(19) United States
(12) Patent Application Publication
(10) Pub. No.: US 2025/0005824 A1
(43) Pub. Date: Jan. 2, 2025

(54) MIX AND MATCH HUMAN IMAGE GENERATION

(71) Applicant: ADOBE INC., SAN JOSE, CA (US)

(72) Inventors: Rishabh Jain, Gurgaon (IN); Mayur Hemani, Noida (IN); Duygu Ceylan Aksit, London (GB); Krishna Kumar Singh, San Jose, CA (US); Jingwan Lu, Sunnyvale, CA (US); Mausoom Sarkar, Noida (IN); Balaji Krishnamurthy, Noida (IN)

(21) Appl. No.: 18/341,982

(22) Filed: Jun. 27, 2023

(51) Int. Cl. G06T 11/60; G06T 3/00; G06T 7/11; G06T 11/00

(52) U.S. Cl. CPC G06T 11/60; G06T 3/18; G06T 7/11; G06T 11/001

(57) ABSTRACT

Systems and methods for image processing are described. One aspect of the systems and methods includes receiving a plurality of images comprising a first image depicting a first body part and a second image depicting a second body part and encoding, using a texture encoder, the first image and the second image to obtain a first texture embedding and a second texture embedding, respectively. Then, a composite image is generated using a generative decoder, the composite image depicting the first body part and the second body part based on the first texture embedding and the second texture embedding.

### BACKGROUND

The following relates generally to machine learning, and more specifically to machine learning for image processing.

Digital image processing generally refers to the process of making changes to a digital image using a computer or other electronic device. A computer or other electronic device may use an algorithm, a processing network, etc. to make changes to a digital image. In some cases, image processing software may be used for various image processing tasks, such as image editing, image generation, etc. Some image processing systems may implement machine learning techniques, for example, to perform tasks using predictive models (e.g., without explicitly programing the system for each task), to perform tasks with more accuracy or in less time, to perform tasks using special-purpose hardware, etc.

### SUMMARY

The present disclosure describes systems and methods for image processing. Embodiments of the present disclosure include an image processing apparatus configured to mix-and-match body parts from a set of input images to generate a composite human image depicting the body parts. The image processing apparatus may obtain the set of input images each depicting one or more body parts, segment a body part image from each of the input images, and warp each of the body part images to conform to a target pose. The image processing apparatus may then encode the body part images to obtain texture embeddings for the body part images, and the image processing apparatus may generate the composite human image based on the texture embeddings. The composite human image may include the body parts from the body part images depicted in the target pose.

A method, apparatus, non-transitory computer readable medium, and system for machine learning for image processing are described. One or more aspects of the method, apparatus, non-transitory computer readable medium, and system include receiving a plurality of images comprising a first image depicting a first body part and a second image depicting a second body part; encoding, using a texture encoder, the first image and the second image to obtain a first texture embedding and a second texture embedding, respectively; and generating, using a generative decoder, a composite image depicting the first body part and the second body part based on the first texture embedding and the second texture embedding.

A method, apparatus, non-transitory computer readable medium, and system for machine learning for image processing are described. One or more aspects of the method, apparatus, non-transitory computer readable medium, and system include obtaining training data including a first image depicting a first body part, a second image depicting a second body part and a ground truth composite image; and training, using the training data, an image generation network to generate a composite image depicting a plurality of body parts based on a plurality of input images.

An apparatus, system, and method for machine learning for image processing are described. One or more aspects of the apparatus, system, and method include at least one memory component; at least one processing device coupled to the at least one memory component, where the processing device is configured to execute instructions stored in the at least one memory component; an image generation network including parameters stored in the at least one memory component, where the image generation network is trained to generate a composite image depicting a set of different segmented body parts based on a set of body part images respectively depicting the set of different segmented body parts.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows example results of mix-and-match human image generation according to aspects of the present disclosure.

FIG. 4 shows an example of an architecture for mix-and-match human image generation according to aspects of the present disclosure.

FIG. 5 shows an example of a method for image processing according to aspects of the present disclosure.

FIG. 6 shows an example of an inference process according to aspects of the present disclosure.

FIGS. 7 through 8 show examples of methods for machine learning according to aspects of the present disclosure.

FIG. 9 shows an example a training process according to aspects of the present disclosure.

FIG. 10 shows an example of a computing device for image processing according to aspects of the present disclosure.

### DETAILED DESCRIPTION

The present disclosure describes systems and methods for image processing. Embodiments of the present disclosure include an image processing apparatus configured to mix-and-match body parts from a set of input images to generate a composite human image depicting the body parts.

Image generation (a subfield of digital image processing) may include using a machine learning model to generate images. In some cases, image generation may depend on signals from users via user prompts (e.g., commands). The user prompts may condition the image generation process to output generated images that have certain attributes (e.g., content, color, style, object locations). This process may be referred to as conditional image generation. In some examples, a machine learning model (e.g., a diffusion-based image generation model or a generative adversarial network (GAN)) may be used for conditional image generation.

An image processing apparatus according to one or more embodiments of the disclosure obtains a set of input images each depicting one or more body parts, segment a body part image from each of the input images, and warps each of the body part images to conform to a target pose. The image processing apparatus may then encode the body part images to obtain texture embeddings for the body part images, and the image processing apparatus may generate the composite human image based on the texture embeddings. The composite human image may include the body parts from the body part images depicted in the target pose.

Human images are ubiquitous in digital applications. Many human image processing (e.g., editing) tasks have been explored by the vision community due to the expansive practical applications of these tasks. Commercial applications of human image processing range from human reposing and virtual try-on to three-dimensional (3D) human and scene regeneration. Methods for human image processing may have a range of applications including editing various aspects of a human body one element at a time. For example, a single neural network may be trained for producing accurate reposed images while another may be adept at generating realistic virtual try-on results. In some examples, however, models for human image processing may fail to generate high quality results when asked to perform multiple tasks together (e.g., reposing and generating virtual try-on results).

In some examples, the primary reason for failing to generate good results when performing multiple tasks together is the difficulty of modeling the intersection of different components at a granular or pixel scale. Some methods may mostly utilize an existing single view reposing pipeline to disentangle clothing items with the help of segmentation masks. Even though these methods may allow for learning warping functions for individual cloth components, these methods may not learn to model distinct clothing items jointly. Embodiments of the present disclosure design a training task for a human image processing pipeline that leverages different human body components from multiple views. This training task allows for developing a more robust framework for learning pixel level correspondence for image generation.

In some aspects, generating human images using human body components from multiple views may be referred to as mix-and-match human image generation (MMHIG). According to embodiments of the present disclosure, an image processing apparatus supporting MMHIG may include a framework to disentangle and combine information from human images viewed from multiple sources (e.g., angles) and jointly model a tuple corresponding to a human image (e.g., id, top, bottom, pose). That is, the image processing apparatus may segment body parts or clothing from various images, warp the body parts to conform to a target pose, and generate a composite image including the body parts depicted in the target pose. The image processing apparatus may show an improvement over other state-of-the-art methods which may be used to perform the same process iteratively by editing one element of a tuple at a time.

Because the image processing apparatus may combine body parts from different images using MMHIG rather than generating each body part separately, the image processing apparatus may effectively model the intersection between different human components when generating a human image. In some examples, there may be a significant market opportunity to utilize MMHIG. For example, several fast fashion retailers or apparel retailers may benefit from MMHIG by allowing customers to visualize the fit of different clothing items for various poses. In addition, MMHIG may pave the way for visual recommendation systems in the garment industry. A customer may upload a selfie containing a face, and an image processing apparatus may recommend a combination of clothing items that may best suit the customer. Apart from enhancing the digital experience of customers, MMHIG may also improve the efficiency of image processing software.

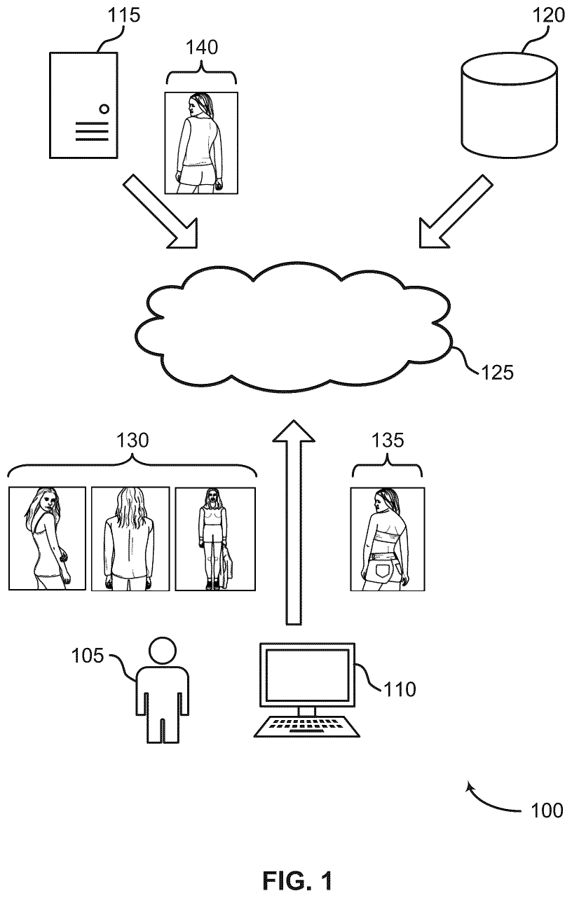

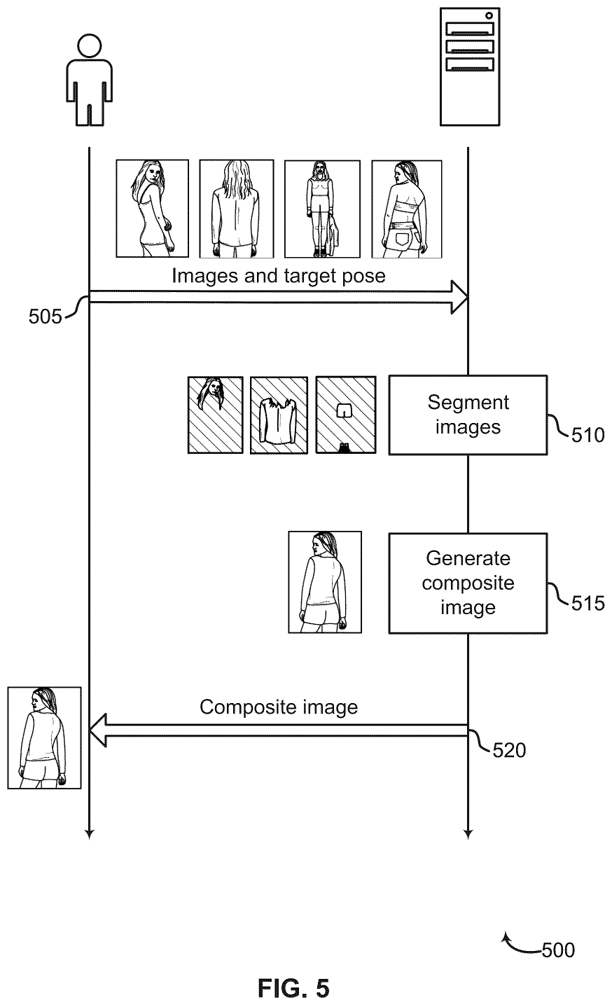

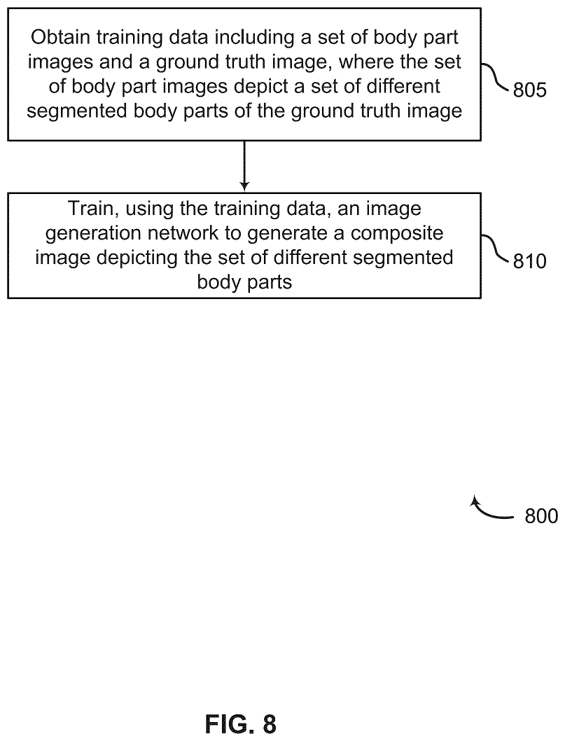

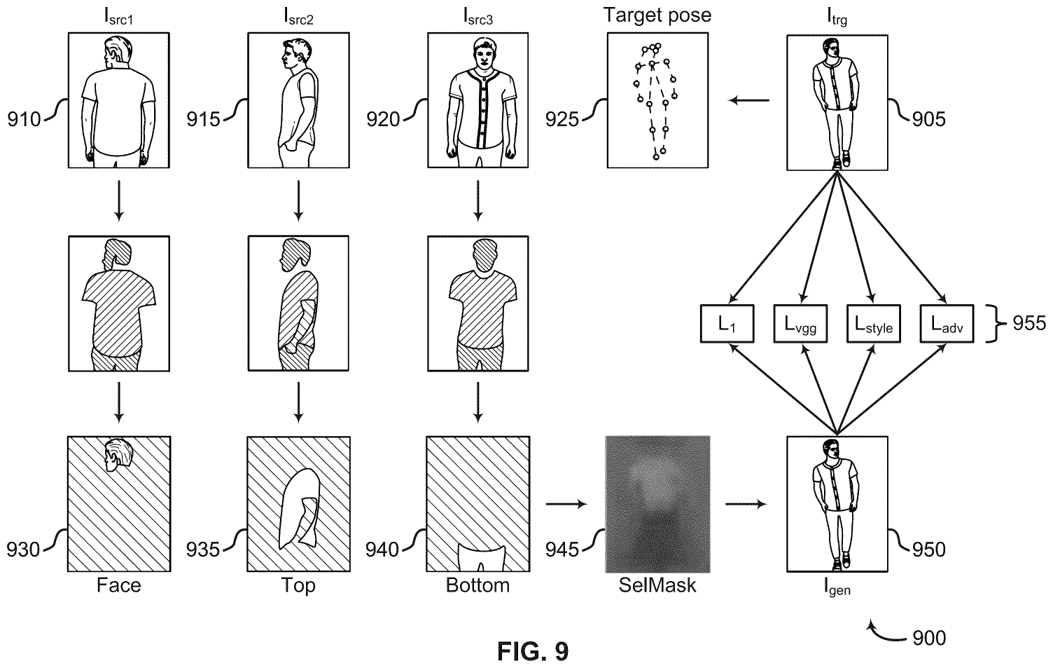

Details regarding the architecture of an example image processing apparatus are provided with reference to FIGS. 1-4. The architecture of the example image processing apparatus may be built on top of a multi-view architecture pipeline to perform MMHIG. In some examples, the architecture may be a neural network architecture for a multi-view human reposing task which may be modified for MMHIG. Example methods for image processing are provided with reference to FIGS. 5-7. Example training processes are described with reference to FIGS. 8 and 9.

### Network Architecture

In FIGS. 1-4, a method, apparatus, non-transitory computer-readable medium, and system for machine learning for image processing are described. One or more aspects of the method, apparatus, non-transitory computer-readable medium, and system include at least one memory component; at least one processing device coupled to the at least one memory component, wherein the processing device is configured to execute instructions stored in the at least one memory component; and an image generation network including parameters stored in the at least one memory component, wherein the image generation network is trained to generate a composite image depicting a plurality of different segmented body parts based on a plurality of body part images respectively depicting the plurality of different segmented body parts.

In some examples, the image generation network includes a feature selector configured to generate a plurality of feature selection masks corresponding to the plurality of body part images. In some examples, the image generation network includes a warper configured to warp the plurality of body part images to obtain a plurality of warped body part images.

In some examples, the image generation network includes a texture encoder configured to encode the plurality of body part images to obtain a plurality of texture embeddings. In some examples, the image generation network includes a pose encoder configured to encode a plurality of input poses to obtain a plurality of pose embeddings. In some examples, the image generation network includes a generative decoder configured to generate the composite image.

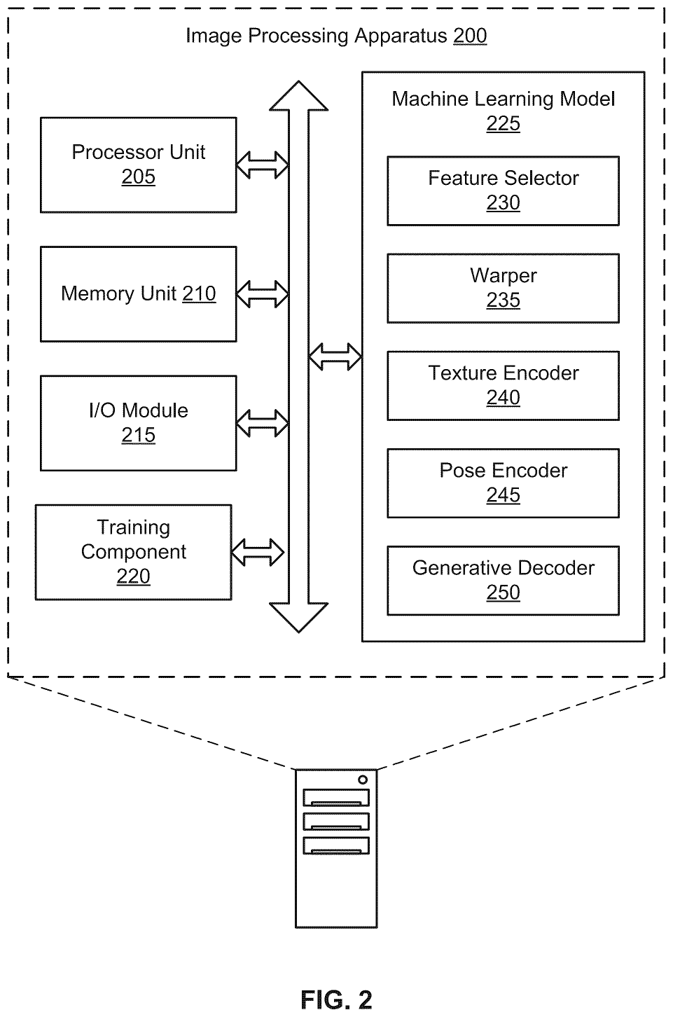

FIG. 1 shows an example of an image processing system 100 according to aspects of the present disclosure. In one aspect, image processing system 100 includes user 105, user device 110, image processing apparatus 115, database 120, and cloud 125. Image processing apparatus 115 is an example of, or includes aspects of, the corresponding element described with reference to FIG. 2.

User 105 may interact with image processing software on user device 110. The user device 110 may communicate with the image processing apparatus 115 via the cloud 125. In some examples, user 105 may provide a set of images 130 (e.g., body images) and a pose image 135 (e.g., depicting a target pose) to the image processing apparatus 115 via the user device 110. The image processing apparatus 115 may then generate a composite image 140 depicting mixed and matched body parts from the set of images 130 conformed to the target pose from the pose image 135. In some examples, the image processing apparatus 115 may upload the composite image 140 to the database 120, or the image processing apparatus 115 may provide the composite image 140 to the user 105 (e.g., via the user device 110). Thus, the image processing apparatus 115 may be used to generate human images that conform to target poses and that include body parts from various images.

In some examples, the image processing apparatus 115 may include a server. A server provides one or more functions to users (e.g., a user 105) linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device (e.g., user device 110), a personal computer, a laptop computer, a mainframe computer, a super computer, or any other suitable processing apparatus.

A database 120 is an organized collection of data. For example, a database 120 stores data in a specified format known as a schema. A database 120 may be structured as a single database, a distributed database, multiple distributed databases, or an emergency backup database. In some cases, a database controller may manage data storage and processing in a database. In some cases, a user 105 interacts with a database controller. In other cases, a database controller may operate automatically without user interaction.

A cloud 125 is a computer network configured to provide on-demand availability of computer system resources, such as data storage and computing power. In some examples, the cloud 125 provides resources without active management by the user 105. The term “cloud” is sometimes used to describe data centers available to many users over the Internet. Some large cloud networks have functions distributed over multiple locations from central servers. A server is designated an edge server if the server has a direct or close connection to a user. In some cases, a cloud 125 is limited to a single organization. In other examples, the cloud 125 is available to many organizations. In one example, a cloud 125 includes a multi-layer communications network comprising multiple edge routers and core routers. In another example, a cloud 125 is based on a local collection of switches in a single physical location.

A user device 110 (e.g., a computing device) is a personal computer, laptop computer, mainframe computer, palmtop computer, personal assistant, mobile device, or any other suitable processing apparatus.

FIG. 2 shows an example of an image processing apparatus 200 according to aspects of the present disclosure. Image processing apparatus 200 is an example of, or includes aspects of, the corresponding element described with reference to FIG. 1. In one aspect, image processing apparatus 200 includes processor unit 205, memory unit 210, I/O module 215, training component 220, and machine learning model 225. In one aspect, the machine learning model 225 includes feature selector 230, warper 235, texture encoder 240, pose encoder 245, and generative decoder 250. In some examples, the machine learning model 225 may be embedded in the memory unit 210, store parameters in the memory unit 210, and/or communicate with the memory unit 210.

Processor unit 205 comprises a processor. Processor unit 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor unit 205 is configured to operate a memory array using a memory controller. In other cases, a memory controller is integrated into the processor unit 205. In some cases, the processor unit 205 is configured to execute computer-readable instructions stored in a memory to perform various functions. In some embodiments, a processor unit 205 includes special-purpose components for modem processing, baseband processing, digital signal processing, or transmission processing.

Memory unit 210 comprises a memory including instructions executable by the processor. Examples of a memory unit 210 include random access memory (RAM), read-only memory (ROM), or a hard disk. Examples of memory units 210 include solid state memory and a hard disk drive. In some examples, memory is used to store computer-readable, computer-executable software including instructions that, when executed, cause a processor to perform various functions described herein. In some cases, the memory unit 210 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory unit 210 store information in the form of a logical state.

I/O module 215 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via I/O controller or via hardware components controlled by an I/O controller.

In some examples, I/O module 215 includes a user interface. A user interface may enable a user to interact with a device. In some embodiments, the user interface may include an audio device, such as an external speaker system, an external display device such as a display screen, or an input device (e.g., remote-control device interfaced with the user interface directly or through an I/O controller module). In some cases, a user interface may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna.

In some examples, image processing apparatus 200 includes a computer-implemented artificial neural network (ANN) to generate classification data for a set of samples. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

In some examples, image processing apparatus 200 includes a computer-implemented convolutional neural network (CNN). A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

In some examples, image processing apparatus 200 includes a transformer. A transformer or transformer network is a type of neural network model used for natural language processing tasks. A transformer network transforms one sequence into another sequence using an encoder and a decoder. The encoder and decoder include modules that can be stacked on top of each other multiple times. The modules comprise multi-head attention and feedforward layers. The inputs and outputs (target sentences) are first embedded into an n-dimensional space. Positional encoding of the different words (i.e., give every word/part in a sequence a relative position since the sequence depends on the order of its elements) is added to the embedded representation (n-dimensional vector) of each word. In some examples, a transformer network includes attention mechanism, where the attention looks at an input sequence and decides at each step which other parts of the sequence are important.

In some embodiments, the attention mechanism uses query, keys, and values denoted by Q, K, and V, respectively. Q corresponds to a matrix that contains the query (vector representation of one word in the sequence), K corresponds to all the keys (vector representations of all the words in the sequence), and V corresponds to the values, which are again the vector representations of all the words in the sequence. For the encoder and decoder, multi-head attention modules, V consists of the same word sequence as Q. However, for the attention module that is taking into account the encoder and the decoder sequences, V is different from the sequence represented by Q. In some cases, values in V are multiplied and summed with some attention-weights a.

The texture encoder 240 is trained to extract textures and other fine features from an image. In some examples, the texture encoder 240 comprises a residual neural network (ResNet). A ResNet is a neural network architecture that addresses issues associated with training deep neural networks. A ResNet operates by including identity shortcut connections that skip one or more layers of the network. In a ResNet, stacking additional layers may not degrade performance or introduce training errors because skipping layers avoids the vanishing gradient problem of deep networks. In other words, the training gradient can follow “shortcuts” through the deep network. Weights may be adjusted to “skip” a layer and amplify a previous, skipped layer. In some cases, weights for an adjacent layer may be adjusted and weights may not be applied to an upstream layer.

In some examples, the generative decoder 250 comprises a generative adversarial network (GAN). A GAN is an ANN in which two neural networks (e.g., a generator and a discriminator) are trained based on a contest with each other. For example, the generator learns to generate a candidate by mapping information from a latent space to a data distribution of interest, while the discriminator distinguishes the candidate produced by the generator from a true data distribution of the data distribution of interest. The generator's training objective is to increase an error rate of the discriminator by producing novel candidates that the discriminator classifies as “real” (e.g., belonging to the true data distribution). Therefore, given a training set, the GAN learns to generate new data with similar properties as the training set. For example, a GAN trained on photographs can generate new images that look authentic to a human observer. GANs may be used in conjunction with supervised learning, semi-supervised learning, unsupervised learning, and reinforcement learning.

In some examples, the training component 215 is implemented as software stored in memory and executable by a processor of a separate computing device, as firmware in the separate computing device, as one or more hardware circuits of the separate computing device, or as a combination thereof. In some examples, training component 215 is part of another apparatus other than image processing apparatus 200 and communicates with the image processing apparatus 200.

According to some aspects, machine learning model 225 obtains a set of body part images, where the set of body part images depict a set of different segmented body parts, respectively. According to some aspects, texture encoder 240 encodes the set of body part images to obtain a set of texture embeddings. According to some aspects, generative decoder 250 generates a composite image depicting the set of different segmented body parts based on the set of texture embeddings.

In some examples, machine learning model 225 obtains a set of body images depicting different bodies and segments the set of body images to obtain the set of body part images. For example, machine learning model 225 may receive a first image depicting a first body part and a second image depicting a second body part.

According to some aspects, warper 235 warps the set of body part images to obtain a set of warped body part images, where the set of texture embeddings are based on the set of warped body part images, respectively. In some examples, warper 235 obtains a target pose, where the warping is based on the target pose.

In some examples, machine learning model 225 generates a set of visibility maps indicating portions of the set of warped body part images based on visible portions of the set of body part images, where the set of texture embeddings are based on the set of visibility maps, respectively.

According to some aspects, feature selector 230 generates a set of feature selection masks corresponding to the set of body part images. In some examples, machine learning model 225 combines each of the set of texture embeddings with a corresponding feature selection mask of the set of feature selection masks to obtain a set of masked texture embeddings, where the composite image is generated based on the set of masked texture embeddings.

According to some aspects, pose encoder 245 obtains a set of input poses corresponding to the set of body part images, respectively, where the composite image is generated based on the set of input poses. In some examples, pose encoder 245 encodes the set of input poses to obtain a set of pose embeddings, where the composite image is generated based on the set of pose embeddings.

In some examples, machine learning model 225 combines each of the set of pose embeddings with a corresponding feature selection mask to obtain a set of masked pose embeddings, where the composite image is generated based on the set of masked pose embeddings.

According to some aspects, training component 220 obtains training data including a set of body part images and a ground truth image, where the set of body part images depict a set of different segmented body parts of the ground truth image. In some examples, training component 220 trains, using the training data, an image generation network (e.g., the machine learning model 225) to generate a composite image depicting the set of different segmented body parts.

In some examples, training component 220 obtains a set of posed images corresponding to the ground truth image and segments the set of posed images to obtain the set of body part images, respectively.

According to some aspects, machine learning model 225 generates a predicted composite image based on the set of body part images. In some examples, training component 220 compares the predicted composite image to the ground truth image, where the training is based on the comparison.

In some examples, training component 220 obtains a target pose for the ground truth image, where the predicted composite image is generated based on the target pose. In some aspects, the image generation network is pretrained using pretraining data prior to training using the training data, where the pretraining data includes non-segmented posed images.

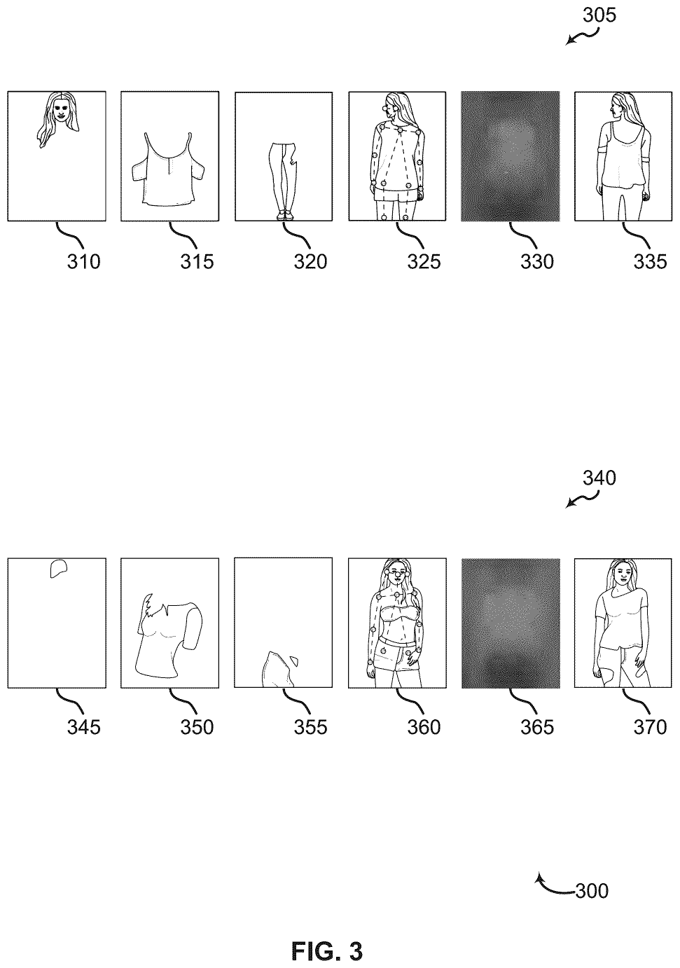

FIG. 3 shows example results 300 of mix-and-match human image generation according to aspects of the present disclosure. Methods for pose-guided human image generation may enable several practical applications, including human reposing and virtual try-on. These methods may take a source image of a person and a target pose guidance as inputs to produce an edited output. In some examples, pose-guided human image generation may be performed iteratively to generate images of different components of a human body to compose a human image. However, performing pose-guided human image generation iteratively may result in compounding of errors and may lack the capacity to effectively model the intersection between different human components. Embodiments of the present disclosure include an image processing apparatus with a robust deep learning framework for jointly modeling different components of a human. The image processing apparatus may be analyzed across different qualitative aspects and compared with previous state-of-the-art iterative neural network architectures (e.g., based on results similar to those shown in FIG. 3).

In a first example 305, an image processing apparatus may receive a first image 310 of a face, a second image 315 of a top, and a third image 320 of a bottom as inputs. The image processing apparatus may also receive a pose image 325 depicting a target pose as input. The image processing apparatus may then generate a selection mask 330 for selecting different components of a human image 335 from the first image 310, the second image 315, and the third image 320, and the image processing apparatus may generate the human image 335 based on the first image 310, the second image 315, the third image 320, the pose image 325, and the selection mask 330.

Even though the first image 310, the second image 315, and the third image 320 may be frontward-facing images, because the image processing apparatus may be trained to generate human images using human body components from multiple views, the image processing apparatus may be capable of generating the human image 335 in the backward-facing, target pose of the pose image 325.

In a second example 340, an image processing apparatus may receive a first image 345 of a face, a second image 350 of a top, and a third image 355 of a bottom as inputs. The image processing apparatus may also receive a pose image 360 depicting a target pose as input. The image processing apparatus may then generate a selection mask 365 for selecting different components of a human image 370 from the first image 345, the second image 350, and the third image 355, and the image processing apparatus may generate the human image 370 based on the first image 345, the second image 350, the third image 355, the pose image 360, and the selection mask 365.

Even though the first image 345, the second image 350, and the third image 355 may be captured from various angles (e.g., may not be front-facing), because the image processing apparatus may be trained to generate human images using human body components from multiple views, the image processing apparatus may be capable of generating the human image 370 in the frontward-facing, target pose of the pose image 365.

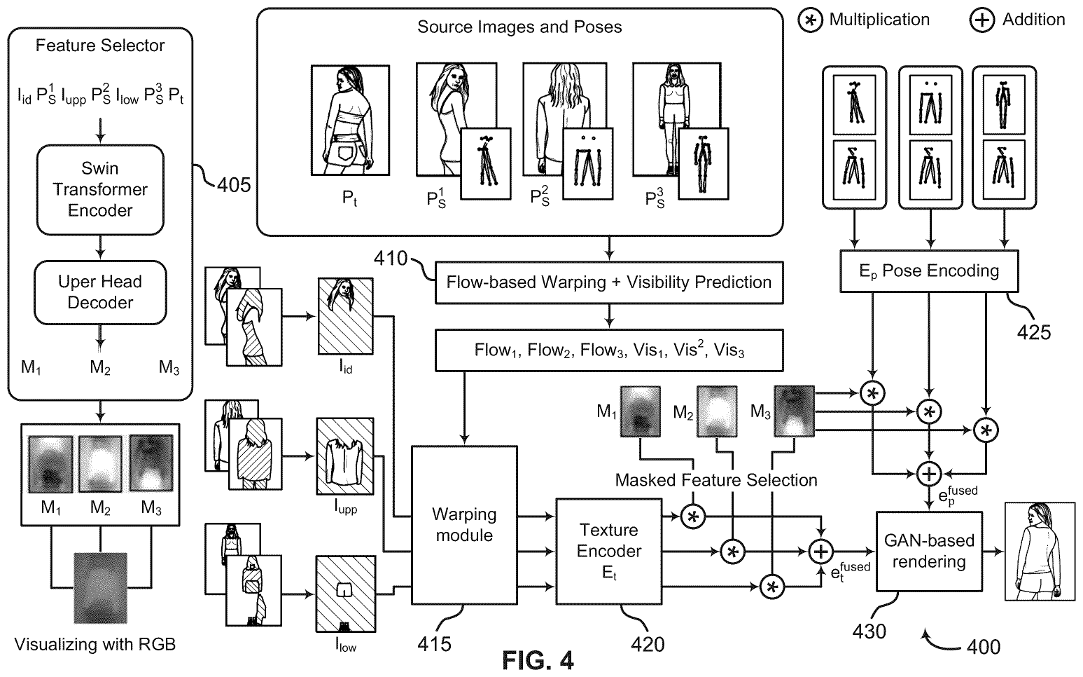

FIG. 4 shows an example of an architecture 400 for mix-and-match human image generation according to aspects of the present disclosure. The architecture 400 may be based on a multi-view human reposing (MVHR) framework. In some examples, an MVHR framework may operate on top of a single-view network (e.g., a single-view, pose-guided image generation (PHIG) network). That is, the single-view network may be adapted to a multi-view network for reposing based on multiple source images. The multi-view network may then be used to combine body components from multiple views to support mix-and-match human image generation. That is, the multi-view network (e.g., a reposing network) may be a versatile network that may be trained to perform a mix-and-match human image generation task where specific parts of source images may be used rather than the entire images.

The multi-view network may obtain source images each depicting at least one body part and a pose image depicting a target pose. Each source image may illustrate a single body part or the single body part may be segmented from the source image (e.g., a full body image). A feature selector 405 of the multi-view network may take the source images as input and may generate a selection mask. The multi-view network may perform flow-based warping and visibility prediction 410 on the source images to warp the source images to conform to the target pose of the pose image and to identify visible regions of each of the warped images in a corresponding source image. In some examples, the flow-based warping may be performed by a warping module 415.

A texture encoder 420 may then generate a texture embedding for each of the source images that captures the texture (e.g., color, shape, and style information) for the source image. The multi-view network may also perform pose encoding 425 to encode poses for each of the source images. Finally, a GAN-based rendering component 430 may generate a human image with mixed and matched body parts from the source images based on the texture embeddings and the pose encodings.

In a single-view network, key points of a source image and target key points of a pose image may be used to produce warped images and a visibility map (I_{w}^{v}, I_{w}ⁱ, Vₜ). The warped images and the visibility map may be used to obtain a texture encoding eₜ, and source images and target poses may be used to obtain a pose encoding eₚ. Together, the texture encoding and the pose encoding may be used to render an output with a GAN-based renderer. In some examples, an architecture of a single-view human reposing network may be similar to a multi-scale appearance flow prediction network architecture of a gated appearance flow-based virtual try-on network. In some examples, the single-view human reposing network may be a visibility-guided flow network for human reposing.

A human reposing task of a single-view human reposing network may consist of transforming a single image (Iₛ) into another image (Iₚ) such that the pose (P(Iₚ)) of the image matches the pose of a target image (Iₜ). The inputs to a reposing network (e.g., a human reposing network) include the source image (Iₛ), the source pose (P(Iₛ)), and the target pose (P(Iₜ)). The output of the reposing network is the image (Iₚ) such that P(Iₜ)≈P(Iₚ). For brevity, the pose of an image (P(Iₓ)) may be written as Pₓ. A procedure performed by the reposing network may include three stages: warping the source image (Iₛ) to match the target pose (Pₜ) as closely as possible; encoding the pose key points Pₛ and Pₜ and the warped images from the warping stage; and decoding the encoded information to generate a final rendition Iₚ of the source image.

The warping stage (W) of human reposing predicts per-pixel 2D displacement fields to warp a source image. The warping stage may take the source image, the source pose, and the target pose as inputs and may predict two flow fields—Fᵥ and Fₜ. Fᵥ represents displacements for regions of the source image that would remain visible when the pose changes to the target. Fₜ represents displacements that produce pixels that are invisible in the source pose but may be predicted using context from the source image. These flow fields are used to sample two warped renditions of the source image—I_{w}^{v} and I_{w}ⁱ. Additionally, a human reposing network also produces a visibility segmentation map Vₜ of the source image as it would appear in the target pose, indicating the regions that are visible and invisible in the source image. Intuitively, the visibility map Vₜ is an indicator of whether the human reposing network can obtain the color information for a pixel from the source image directly, or if the human reposing network may make an informed prediction.

An encoder stage of human reposing consists of two components—a texture encoder (Eₜ) and a pose encoder (Eₚ). Both encoders may be based on a ResNet architecture. The texture encoder captures the color, shape, and style information for the source image as it would appear in the target pose by combining information from I_{w}^{v}, I_{w}ⁱ, and Vₜ. The pose encoder produces a latent representation for the source and target key points (Pₛ, Pₜ) that can be used to condition the generation of a human image (e.g., a person image) to make it conform to the target pose. A decoder stage (D) of human reposing may be performed by a dual ResNet-style decoder network that transforms the encoded pose and texture information into an RGB output image Iₚ. A first branch of the decoder processes the encoded pose information, while the activations of each layer of a second branch modulate the output of a corresponding layer of the first branch. The process of single-view human reposing may be summarized by the following equations: I_{w}^{v}, I_{w}ⁱ, Vₜ=W(Iₛ, Pₛ, Pₜ), eₜ=Eₜ(I_{w}^{v}, I_{w}ⁱ, Vₜ), eₚ=Eₚ(Pₛ, Pₜ), and Iₚ=D(eₜ, eₚ).

Although a single-view network may be capable of generating a human image in a target pose, in some examples, it may be appropriate to utilize multiple views in human reposing (e.g., employ multiple inputs for a PHIG task). For example, if a target pose is significantly different from a source pose, a PHIG network may not accurately predict the pixel colors for those pixels that are in invisible regions. Inaccurate pixel color prediction of PHIG networks is evident in extreme cases where either a source pose or a target pose is frontward facing and the other is backward facing. In addition, for non-extreme cases, results may indicate a high degree of overlap between error regions for test images and invisible regions in corresponding ground-truth visibility maps.

Even if source and target poses are similar in terms of the relative arrangements of key points, camera viewpoints of the source and target poses may differ. Also, clothing may deform in a non-rigid manner between source poses and target poses. These factors also contribute to appearance artifacts in the output of a single-view reposing network. Utilizing multiple source images may therefore help improve the output quality of a reposing network because the source images may contain visible cues appropriate for the target pose. Thus, in some aspects, a single-view network may be adapted or transformed to a multi-view network utilizing multiple source images or views. The multi-view network may produce superior results by effectively fusing information from multiple source images (e.g., up to three source images).

In a multi-view adaptation of a single-view network, multiple source images and poses may be passed individually to warping and visibility prediction modules to obtain multiple warped images and visibility maps, which may then be used to obtain multiple texture-encoding vectors. In addition, the source poses paired with the target pose may be used to obtain multiple pose encoding vectors. The texture-encoding vectors and the pose encoding vectors may be combined in an affine combination with the weights represented as two-dimensional (2D) masks (M₁₋₃) (e.g., obtained using a multi-view fusion model), and the resulting combination may be used to generate a human image. A multi-view network may employ a feature selection approach for combining multiple source input images.

A feature selector predicts a 2D soft-selection mask for each of the inputs. The inputs to the feature selection component include a channel-wise concatenation of the source images Iₛ^{1:3}, corresponding key point representations of the source images Pₛ^{1:3}, and the target key point representation (Pₜ). The output of the feature selector is a 2D mask with as many channels as the number of input images. In some examples, a feature selector may take three input source images. A combined soft-selection volume has dimensions H×W×3. Intuitively, each (row, col) position of the combined soft-selection volume represents the probability of deriving the output pixel at that position from one of the three source images. The problem of predicting a per-pixel soft-selection mask is posed as a joint, conditional soft attention over the input images where conditioning is on the target pose. This problem may be modeled as an attention prediction task to ensure that produced weights represent the joint probability of an output pixel being derived from a source image.

A feature selector may include a network adapted from a Swin Transformer with an Uper head. The Swin transformer captures the inter-channel relationships in the input (e.g., between the input images and key point representations) using self and cross attention between shifted windows. The computational complexity of the feature selector is linear in the size of the output which makes it useful for high-resolution input and output. The Uper head may be highly accurate for per-pixel segmentation due to its ability to merge information from multiple scales. The selection masks s_{1:3} are obtained by applying SoftMax on the output of the Uper head at a resolution of 128×128. The selection masks s_{1:3} are used to fuse the pose and texture features for the corresponding source images (Iₛ^{1:3}). The fusion is done with the features and not the images themselves to ensure that non-local information present in each image can be combined effectively into the resulting fused features (eₜ^{fused} and eₚ^{fused}).

The process of multi-view human reposing may be summarized by the following equations: I_{w}^{v,k}, I_{w}^{i,k}, Vₜ^{k}=W(Iₛ^{k}, Pₛ^{k}, Pₜ), eₜ^{k}=Eₜ(I_{w}^{v,k}, I_{w}^{i,k}, Vₜ^{k}), eₚ^{k}=Eₚ(Pₛ^{k}, Pₜ), s^{1:3}=Softmax(S([Iₛ^{k}]_{k=1:3}, [Pₛ^{k}]_{k=1:3}, Pₜ)), eₜ^{fused}=eₜ¹·s¹⊕eₜ²·s²⊕eₜ³·s³, eₚ^{fused}=eₚ¹·s¹+eₚ²·s₂+eₚ³·s³, Iₚ=D(eₜ^{fused}, eₚ^{fused}). The ⊕ operation is used to indicate that the arithmetic addition happens at multiple scales (e.g., with feature pyramids) and not just with the end activations of the encoding process. The selection masks are resized to match the spatial dimensions of the features (eₜ^{1:3} and eₚ^{1:3}) using bilinear interpolation. In some examples, a multi-view human reposing network may be used for multiple PHIG tasks. For instance, training objectives may be developed for MMHIG and specific adaptations may be made to a multi-view network for MMHIG.

A multi-view network may be trained to combine images of different people to produce a new human image (e.g., without making any changes to the network itself). To reduce the ambiguity in multiple views of source images, an input sequence may include images depicting a source of a person's identity (e.g., face and hair) I_{id}, upper clothing Iᵤₚₚ, and lower clothing I_{low} in that order. A human body parsing network may discard irrelevant pixels of full-body images (e.g., the body pixels for I_{id}) before using the images as input to the network. For MMHIG task training, a single-view PHIG network may work normally to generate flow fields, a visibility map, and pose encodings. For the texture encoding, an input source image may be segmented into a desired region and then warped with the predicted flow field. This segmented warped image goes into the texture encoder to produce the texture encodings (Eₜₑₓ).

For a multi-view fusion module, the segmented region of source images in different poses may be given as input to produce a selection mask. By learning to disentangle these elements in a supervised fashion, a multi-view network is able to produce accurate and realistic images. Note that editing only the pose element may result in a single-view human reposing task, changing a top or bottom element of the tuple is referred to as a virtual try-on, and changing an ID results in identity swapping.

Although each of these tasks may be performed individually, a multi-view network supporting MMHIG may model these tasks together. Performing edits sequentially on different parts of a tuple may result in inferior output quality. Networks that perform edits sequentially may not be able to handle the intersection of regions between clothing items and body parts successfully which often results in bleeding and bad texture reproduction. Also, the compounding of errors introduced by these sequential edits result in identity deterioration and inadequate occlusion handling. These findings may be observed by comparing the qualitative and quantitative results of MMHIG performed by the architecture in FIG. 4 with a model that performs sequential edits.

### Image Processing

In FIGS. 5-8, a method, apparatus, non-transitory computer-readable medium, and system for machine learning for image processing are described. One or more aspects of the method, apparatus, non-transitory computer readable medium, and system include obtaining a plurality of body part images, wherein the plurality of body part images depict a plurality of different segmented body parts, respectively; encoding the plurality of body part images to obtain a plurality of texture embeddings; and generating a composite image depicting the plurality of different segmented body parts based on the plurality of texture embeddings.

Some examples of the method, apparatus, non-transitory computer readable medium, and system further include obtaining a plurality of body images depicting different bodies. Some examples further include segmenting the plurality of body images to obtain the plurality of body part images. Some examples of the method, apparatus, non-transitory computer readable medium, and system further include warping the plurality of body part images to obtain a plurality of warped body part images, wherein the plurality of texture embeddings are based on the plurality of warped body part images, respectively.

Some examples of the method, apparatus, non-transitory computer readable medium, and system further include obtaining a target pose, wherein the warping is based on the target pose. Some examples of the method, apparatus, non-transitory computer readable medium, and system further include generating a plurality of visibility maps indicating portions of the plurality of warped body part images based on visible portions of the plurality of body part images, wherein the plurality of texture embeddings are based on the plurality of visibility maps, respectively.

Some examples of the method, apparatus, non-transitory computer readable medium, and system further include generating a plurality of feature selection masks corresponding to the plurality of body part images. Some examples further include combining each of the plurality of texture embeddings with a corresponding feature selection mask of the plurality of feature selection masks to obtain a plurality of masked texture embeddings, wherein the composite image is generated based on the plurality of masked texture embeddings.

Some examples of the method, apparatus, non-transitory computer readable medium, and system further include obtaining a plurality of input poses corresponding to the plurality of body part images, respectively, wherein the composite image is generated based on the plurality of input poses. Some examples of the method, apparatus, non-transitory computer readable medium, and system further include encoding the plurality of input poses to obtain a plurality of pose embeddings, wherein the composite image is generated based on the plurality of pose embeddings. Some examples of the method, apparatus, non-transitory computer readable medium, and system further include combining each of the plurality of pose embeddings with a corresponding feature selection mask to obtain a plurality of masked pose embeddings, wherein the composite image is generated based on the plurality of masked pose embeddings.

FIG. 5 shows an example of a method 500 for image processing according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

An image processing apparatus may include a framework for effectively combining information from multiple source images in a pose-guided human image generation pipeline to generate a human image. An approach for generating the human image includes using a feature selection strategy that produces explicit 2D weight masks for combining features from multiple source images and the corresponding poses of the source images. This approach may be effective on mix-and-match human image generation with state-of-the-art results both qualitatively and quantitatively. In addition, results of human image generation using this approach may indicate a pragmatic approach to producing good results in pose-guided human image generation tasks. The operations described herein may facilitate mix-and-match human image generation.

At operation 505, a user provides source images and a pose image to an image processing apparatus. The source images may each include a different body part to be included in a composite image, and the pose image may depict a target pose for the composite image. In some cases, the operations of this step refer to, or may be performed by, a user as described with reference to FIG. 1.

At operation 510, the image processing apparatus may segment each of the source images to identify a different body part to include in the composite image. For instance, each of the source images may depict a full body and the image processing apparatus may segment a different body part from each of the source images. In some cases, the operations of this step refer to, or may be performed by, a machine learning model as described with reference to FIG. 2.

At operation 515, the image processing apparatus may generate a composite image based on the segmented images. The image processing apparatus may warp each of the source images and generate texture embeddings for each of the source images. The image processing apparatus may also generate pose encodings for each of the source images. The image processing apparatus may combine the texture embedding for each source image with a corresponding selection mask, and the image processing apparatus may combine the pose encoding for each source image with a corresponding selection mask. The image processing apparatus may then generate the composite image based on the texture embeddings and the pose encodings. In some cases, the operations of this step refer to, or may be performed by, a machine learning model as described with reference to FIG. 2.

At operation 520, the image processing apparatus may provide the composite image to the user. The composite image may include segmented body parts from each of the source images provided as input and may conform to a target pose of a pose image provided as input. In some cases, the operations of this step refer to, or may be performed by, an image processing apparatus as described with reference to FIGS. 1 and 2.

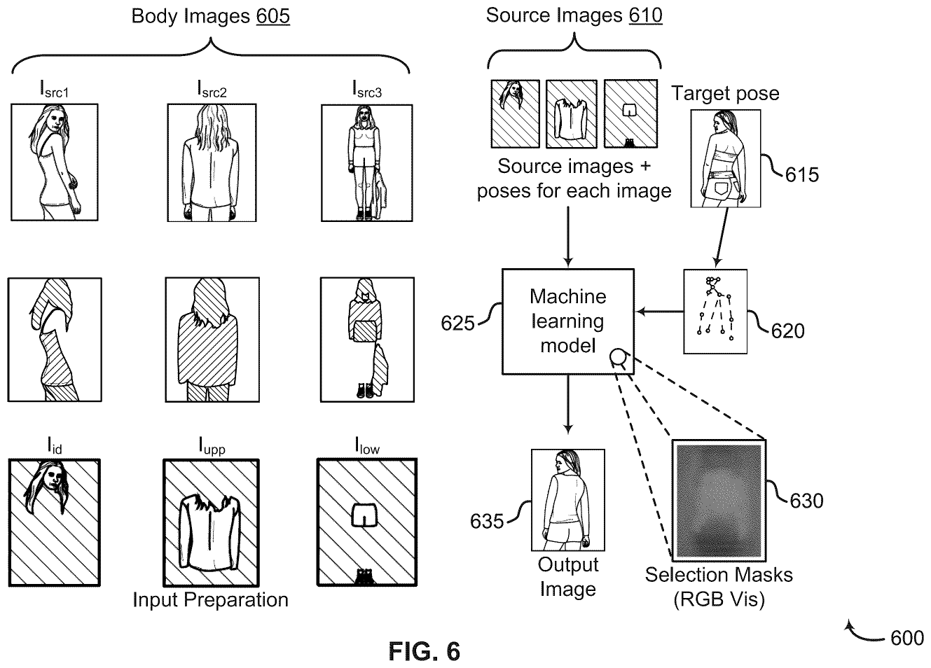

FIG. 6 shows an example of an inference process 600 according to aspects of the present disclosure. During inference, an image processing apparatus may obtain multiple body images 605 each depicting a different body part to be included in a composite image. The image processing apparatus may segment the body images to produce source images 610 each depicting the different body part to be included in the composite image. For instance, the image processing apparatus may use a human body parsing solution to prepare a face (I_{id}), upper clothing (Iᵤₚₚ), and lower clothing (h_{low}). The image processing apparatus may also obtain a pose image 615 depicting a target pose 620 for the composite image. The image processing apparatus may use an open pose algorithm to determine the target pose 620 based on the pose image 615. The image processing apparatus may then use a machine learning model 625 (e.g., a unified multi-view fusion (UMFuse) model) to generate the composite image 635. The machine learning model 625 may generate selection masks 630 to identify the body parts from the source images 610 to be included in the composite image 635.

Composite images generated using the inference process 600 may accurately and realistically depict body parts from different source images while conforming to specified target poses. Results of the inference process 600 may be evaluated with a dataset of 52,712 high-quality person images with plain backgrounds. The dataset may be split into 48,674 training images and 4038 testing images, and images in the dataset may be resized to a resolution of 256×256. Quality metrics may be reported for the inference process 600 for training and test splits created specifically for an MMHIG task. In total, 720,949 training and 10,000 testing quadruples may be formed from a deep-fashion split. A set of quadruples (e.g., containing id, top, bottom, and pose) for training and evaluating a multi-view pipeline may be created, ensuring that the training and test splits have persons with different identities. For every 4-tuple of images, the training quadruples include all

$$( \begin{matrix}4 \\ 3\end{matrix} )$$

combinations as inputs to the network and the remaining image as ground truth. For evaluation, 10000 random 4-typles of (I_{id}, Iₚₚ, I_{low}, Iₜ) may be sampled from the test images for inference. The pose Pₜ may correspond to the last image It in each quadruple.

For a mix-and-match quantitative evaluation, an FID score may be used as there is no ground truth available for comparison. FID measures the realness of an image by comparing the 2-wasserstein distance between the InceptionNet statistics of the generated images and ground truth dataset. An inception score may be avoided since it may be shown to be a suboptimal metric. A neural network architecture may be implemented using a PyTorch framework. For an MMHIG task, a batch size of 24 may be used, a learning rate of 3×10⁻⁴ may be used, and training may be performed for 10 epochs. Network weights may be initialized from a multi-view reposing task training checkpoint to allow for faster convergence.

The inference process 600 may be compared to a human editing process that change a single element of a tuple (id, top, bottom, pose) at a time. A network implementing such a human editing process may be capable of recursively performing edits on top of a human image. Therefore, the network may be used to perform edits in the order of pose change, hair try-on, top try-on, jacket try-on, and bottom try-on (e.g., based on recommendations). Note that the order of performing the edits changes the final output image. Outputs generated by the network recursively performing edits on top of a human image may be compared to outputs of the inference process 600. The comparison of an image processing apparatus implementing the inference process 600 to a network recursively performing edits may show a FID drop from 21.73 to 14.71.

For a mix-and-match qualitative comparison, a human image generation quality and improvements over a baseline may be analyzed for the inference process 600. The inference process 600 may show proficiency in modelling the intersection of different body parts and garments of a human body using a per-pixel selection mask. This may be confirmed by visualizing a selection mask. In an RGB mask, a red value may represent selection weights for the features of a first source image (e.g., an ID), a green value for a second source image (e.g., a top), and a blue value for a third source image (e.g., a bottom). A face may be derived at the top region (e.g., red), a shirt may be derived at the middle (e.g., green), and a bottom may be derived at a lower region (e.g., blue). A skin region may be hallucinated using information from a combination of a face region combined with other sources. A body shape may also be better preserved.

In some examples, the inference process 600 may also show superiority in modelling a complex pose, combining intricate texture (e.g., preserving frills), maintaining geometric details of a fabric (e.g., a checkerboard pattern), inpainting occluded regions (e.g., of a dress), and performing backpose hallucination. In some examples, the inference process 600 may produce an accurate representation of multiple top garments with natural looking lower clothing. Thus, the inference process 600 may show realistic generation quality while preserving body shape, modelling a complex pose, depicting a complicated design and texture of cloth, showing heavy occlusions, being provided with missing information, showing multiple clothing garments with accessories, etc. Overall, the inference process 600 may produce perceptually convincing output for variations in any element of a tuple (e.g., id, top, bottom, pose).

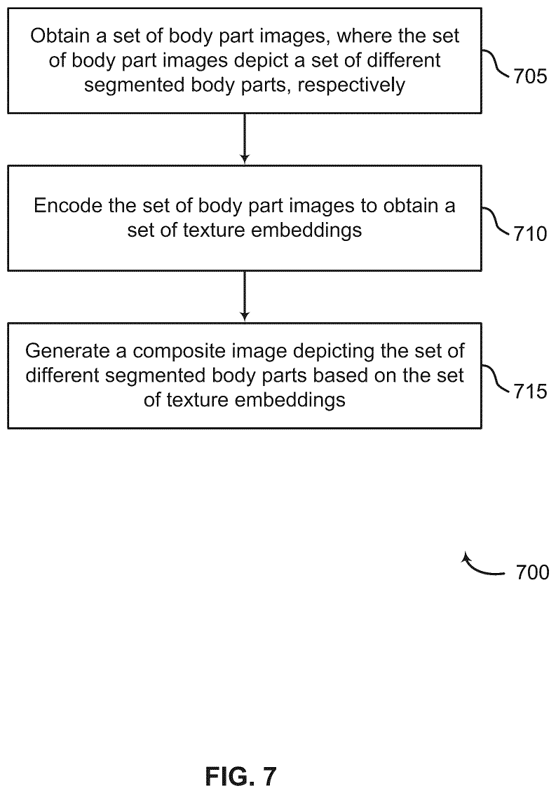

FIG. 7 shows an example of a method 700 for machine learning according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains a set of body part images, where the set of body part images depict a set of different segmented body parts, respectively. For example, a machine learning model may receive a plurality of images comprising a first image depicting a first body part and a second image depicting a second body part. In some cases, the operations of this step refer to, or may be performed by, a machine learning model as described with reference to FIG. 2.

At operation 710, the system encodes the set of body part images to obtain a set of texture embeddings. For example, a texture encoder may encode the first image and the second image to obtain a first texture embedding and a second texture embedding, respectively. In some cases, the operations of this step refer to, or may be performed by, a texture encoder as described with reference to FIG. 2.

At operation 715, the system generates a composite image depicting the set of different segmented body parts based on the set of texture embeddings. For example, a generative decoder may generate a composite image depicting the first body part and the second body part based on the first texture embedding and the second texture embedding. In some cases, the operations of this step refer to, or may be performed by, a generative decoder as described with reference to FIG. 2.

### Training

In FIGS. 8 and 9, a method, apparatus, non-transitory computer-readable medium, and system for machine learning for image processing are described. One or more aspects of the method, apparatus, non-transitory computer readable medium, and system include obtaining training data including a plurality of body part images and a ground truth image, wherein the plurality of body part images depict a plurality of different segmented body parts of the ground truth image and training, using the training data, an image generation network to generate a composite image depicting the plurality of different segmented body parts.

Some examples of the method, apparatus, non-transitory computer readable medium, and system further include obtaining a plurality of posed images corresponding to the ground truth image. Some examples further include segmenting the plurality of posed images to obtain the plurality of body part images, respectively. Some examples of the method, apparatus, non-transitory computer readable medium, and system further include generating a predicted composite image based on the plurality of body part images. Some examples further include comparing the predicted composite image to the ground truth image, wherein the training is based on the comparison.

Some examples of the method, apparatus, non-transitory computer readable medium, and system further include obtaining a target pose for the ground truth image, wherein the predicted composite image is generated based on the target pose. In some aspects, the image generation network is pretrained using pretraining data prior to training using the training data, wherein the pretraining data includes non-segmented posed images.

FIG. 8 shows an example of a method 800 for machine learning according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains training data including a set of body part images and a ground truth image, where the set of body part images depict a set of different segmented body parts of the ground truth image. For example, the training component may obtain a first image depicting a first body part, a second image depicting a second body part and a ground truth composite image depicting the first body part and the second body part. In some cases, the operations of this step refer to, or may be performed by, a training component as described with reference to FIG. 2.

At operation 810, the system trains, using the training data, an image generation network to generate a composite image depicting the set of different segmented body parts. For example, the training component may train the image generation network to generate a composite image depicting the first body part and the second body part based on the first image and the second image. In some cases, the operations of this step refer to, or may be performed by, a training component as described with reference to FIG. 2.

FIG. 9 shows an example of a training process 900 according to aspects of the present disclosure. The objectives of the training process 900 may include: minimizing distances between output and ground-truth images (Iₚ and I_{gt}) and minimizing an adversarial loss based on multi-class GANs with an L2 loss function (L_{adv}) for the output image. Training to minimize the adversarial loss may be useful to render a realistic output, especially for regions where a decoder may guess pixel colors. In some examples, the distances between output and ground-truth images may include a pixel-wise mean of absolute different (L₁) for an exact pattern and shape reproduction. In some examples, the distances between output and ground-truth images may include VGG-features based on perceptual differences (L_{vgg}). In some examples, the distances between output and ground-truth images may include a style difference measured using a mean-squared difference between the Gram-matrices (L_{sty}). Perceptual and style losses may help to preserve semantic features taken from input images, such as the identity of a person and a garment style.

The training of an image processing apparatus to generate a composite, human image may be done with 4-tuples of the same person. For instance, in an iteration of the training process 900, the image processing apparatus may be given a target image 905, a first source image 910, a second source image 915, and a third source image 920 as inputs. The target image 905 may correspond to both a pose image and a target image for the image processing apparatus to attempt to regenerate.

The image processing apparatus may determine the target pose 925 based on the target image 905. The image processing apparatus may then segment the first source image 910 to obtain a first body part image 930 (e.g., a face), segment the second source image 915 to obtain a second body part image 935 (e.g., a top), and segment the third source image 920 to obtain a third body part image 940 (e.g., a bottom). The image processing apparatus may generate a selection mask 945 for selecting different parts of the first body party image 930, the second body part image 935, and the third body party image 940 to be included in the composite image. The image processing apparatus may then generate composite image 950 based on the selection mask and the body part images 930-940.

A training component may compare the composite image 950 to the target image 905 to calculate losses 955 for training the image processing apparatus. A total loss for training the image processing apparatus may include an L₁ loss, an L_{vgg} loss, an L_{style} loss, and an L_{adv} loss. The total loss may be defined as: L(Iₚ, I_{gt})=α_{rec}∥Iₚ, Iₜ∥₁+αₚₑᵣL_{vgg}(Iₚ, I_{gt})+α_{sty}L_{sty}(Iₚ, Iₜ)+α_{adv}L_{adv}(Iₚ, Iₜ). In an MMHIG task, a feature selector may produce accurate region selection masks attributing information to the appropriate source inputs to produce accurate and realistic output images. This attribution may explain the operation of the network as a selector of image regions for reproducing a correct output image.

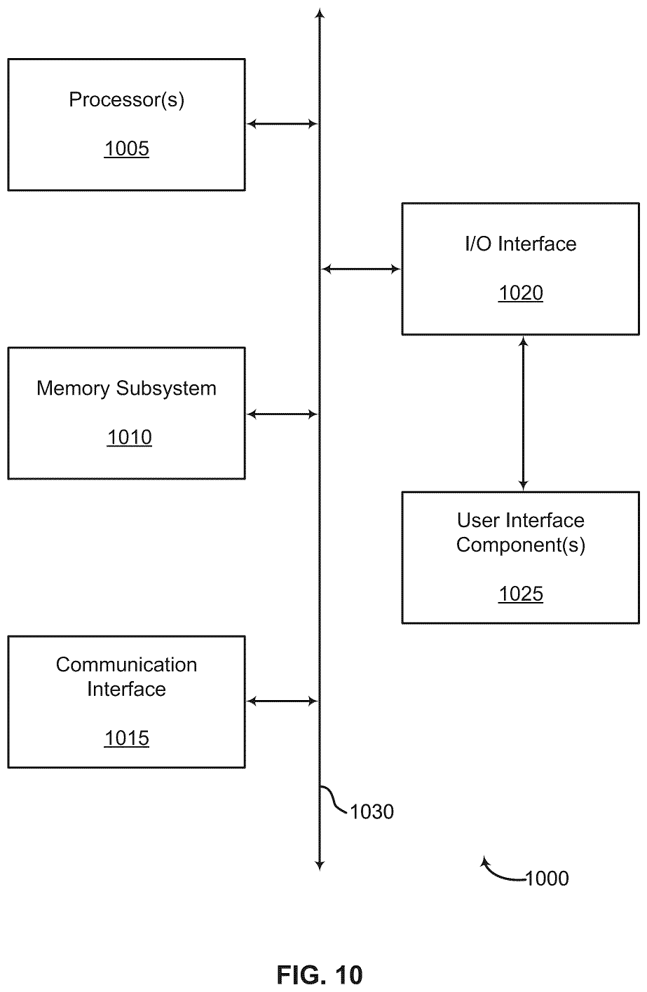

FIG. 10 shows an example of a computing device 1000 for image processing according to aspects of the present disclosure. In one aspect, computing device 1000 includes processor(s) 1005, memory subsystem 1010, communication interface 1015, I/O interface 1020, user interface component(s) 1025, and channel 1030.

In some embodiments, computing device 1000 is an example of, or includes aspects of, image processing apparatus 200 of FIG. 2. In some embodiments, computing device 1000 includes one or more processors 1005 that can execute instructions stored in memory subsystem 1010 for obtaining a set of body part images, where the set of body part images depict a set of different segmented body parts, respectively; encoding the set of body part images to obtain a set of texture embeddings; and generating a composite image depicting the set of different segmented body parts based on the set of texture embeddings.

According to some aspects, computing device 1000 includes one or more processors 1005. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1015 operates at a boundary between communicating entities (such as computing device 1000, one or more user devices, a cloud, and one or more databases) and channel 1030 and can record and process communications. In some cases, communication interface 1015 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1020 is controlled by an I/O controller to manage input and output signals for computing device 1000. In some cases, I/O interface 1020 manages peripherals not integrated into computing device 1000. In some cases, I/O interface 1020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1020 or via hardware components controlled by the I/O controller.

According to some aspects, user interface component(s) 1025 enable a user to interact with computing device 1000. In some cases, user interface component(s) 1025 include an audio device, such as an external speaker system, an external display device such as a display screen, an input device (e.g., a remote-control device interfaced with a user interface directly or through the I/O controller), or a combination thereof. In some cases, user interface component(s) 1025 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
receiving a plurality of images comprising a first image depicting a first body part and a second image depicting a second body part;
encoding, using a texture encoder, the first image and the second image to obtain a first texture embedding and a second texture embedding, respectively; and
generating, using a generative decoder, a composite image depicting the first body part and the second body part based on the first texture embedding and the second texture embedding.

2. The method of claim 1, further comprising:
obtaining a plurality of body images depicting different bodies; and
segmenting the plurality of body images to obtain the plurality of images.

3. The method of claim 1, further comprising:
warping the first image and the second image to obtain a first warped image and a second warped image, wherein the first texture embedding and the second texture embedding are based on the first warped image and the second warped image, respectively.

4. The method of claim 3, further comprising:
obtaining a target pose, wherein the warping is based on the target pose.

5. The method of claim 3, further comprising:
generating a first visibility map and a second visibility map indicating portions of the first warped image and the second warped image based on visible portions of the first image and the second image, respectively, wherein the first texture embedding and the second texture embedding are based on the first visibility map and the second visibility map, respectively.

6. The method of claim 1, further comprising:
generating a first feature selection mask and a second feature selection mask corresponding to the first image and the second image, respectively; and
combining the first texture embedding and the second texture embedding with the first feature selection mask and the second feature selection mask, respectively, to obtain a first masked texture embedding and a second masked texture embedding, wherein the composite image is generated based on the first masked texture embedding and the second masked texture embedding.

7. The method of claim 1, further comprising:
obtaining a plurality of input poses corresponding to the plurality of images, respectively, wherein the composite image is generated based on the plurality of input poses.

8. The method of claim 7, further comprising:
encoding the plurality of input poses to obtain a plurality of pose embeddings, wherein the composite image is generated based on the plurality of pose embeddings.

9. The method of claim 8, further comprising:
combining each of the plurality of pose embeddings with a corresponding feature selection mask to obtain a plurality of masked pose embeddings, wherein the composite image is generated based on the plurality of masked pose embeddings.

10. A method comprising:
obtaining training data including a first image depicting a first body part, a second image depicting a second body part and a ground truth composite image; and
training, using the training data, an image generation network to generate a composite image depicting a plurality of body parts based on a plurality of input images.

11. The method of claim 10, further comprising:
obtaining a plurality of posed images corresponding to the ground truth image; and
segmenting the plurality of posed images to obtain the first image and the second image.

12. The method of claim 10, further comprising:
generating a predicted composite image based on the first image and the second image; and
comparing the predicted composite image to the ground truth image, wherein the training is based on the comparison.

13. The method of claim 12, further comprising:
identifying a target pose for the ground truth image, wherein the predicted composite image is generated based on the target pose.

14. The method of claim 10, wherein:
the image generation network is pretrained using pretraining data prior to training using the training data, wherein the pretraining data includes non-segmented posed images.

15. A system comprising:
at least one memory component;
at least one processing device coupled to the at least one memory component, wherein the processing device is configured to execute instructions stored in the at least one memory component; and
an image generation network including parameters stored in the at least one memory component, wherein the image generation network is trained to generate a composite image depicting a plurality of different segmented body parts based on a plurality of body part images respectively depicting the plurality of different segmented body parts.

16. The system of claim 15, wherein the image generation network comprises:
a feature selector configured to generate a plurality of feature selection masks corresponding to the plurality of body part images.

17. The system of claim 15, wherein the image generation network comprises:
a warper configured to warp the plurality of body part images to obtain a plurality of warped body part images.

18. The system of claim 15, wherein the image generation network comprises:
a texture encoder configured to encode the plurality of body part images to obtain a plurality of texture embeddings.

19. The system of claim 15, wherein the image generation network comprises:
a pose encoder configured to encode a plurality of input poses to obtain a plurality of pose embeddings.

20. The system of claim 15, wherein the image generation network comprises:
a generative decoder configured to generate the composite image.
